(19) United States
(12) Patent Application Publication
(10) Pub. No.: US 2022/0307487 A1
(43) Pub. Date: Sep. 29, 2022

(54) SUPPORT MEMBER FOR AN ELECTROCHEMICAL CELL AND ELECTROCHEMICAL HYDROGEN COMPRESSOR

(71) Applicant: HONDA MOTOR CO., LTD., Tokyo (JP)

(72) Inventors: Shoji TAKASUGI, WAKO-SHI (JP); Toru HONDA, WAKO-SHI (JP)

(21) Appl. No.: 17/677,065

(22) Filed: Feb. 22, 2022

(30) Foreign Application Priority Data
Mar. 25, 2021 (JP) 2021-051655
Jan. 17, 2022 (JP) 2022-004927

(51) Int. Cl. F04B 17/00; H01M 8/04082

(52) U.S. Cl. CPC F04B 17/00; H01M 8/04201

(57) ABSTRACT

An electrochemical hydrogen compressor and a support member for an electrochemical cell include, in a flow field member, flow field grooves through which an anode gas (for example, a hydrogen gas) is allowed to flow in a predetermined direction, and a plurality of through holes one ends of which open in the flow field grooves, and other ends of which are in communication with ventilation holes of an anode current conductor. At least a portion of the through holes (for example, discharge through holes) are inclined at an acute angle with respect to an upstream side of the flow field grooves (for example, discharge flow field grooves).

### CROSS-REFERENCE TO RELATED APPLICATIONS

This application is based upon and claims the benefit of priority from Japanese Patent Application No. 2021-051655 filed on Mar. 25, 2021 and Japanese Patent Application No. 2022-004927 filed on Jan. 17, 2022, the contents of which are incorporated herein by reference.

### BACKGROUND OF THE INVENTION

### Field of the Invention

The present invention relates to a support member for an electrochemical cell containing an electrolyte membrane through which hydrogen is transported, and an electrochemical hydrogen compressor.

### Description of the Related Art

An electrochemical cell includes an electrolyte membrane that possesses hydrogen ion conductivity, and catalyst layers and electrodes disposed on both surfaces of the electrolyte membrane. Such an electrochemical cell is used in a fuel cell, a water electrolyzing device, an electrochemical hydrogen compressor, and the like. Among such devices, the electrochemical hydrogen compressor is of the same configuration as the water electrolyzing device. The electrochemical hydrogen compressor is capable of producing high pressure hydrogen required for a fuel cell electric vehicle or the like in only one stage. Such an electrochemical hydrogen compressor has the advantage of being smaller and quieter than a mechanical hydrogen compressor.

In such an electrochemical hydrogen compressor, a differential pressure acts on the electrolyte membrane. Therefore, in a portion adjacent to the electrolyte membrane, the electrochemical hydrogen compressor includes a support member for supporting the electrolyte membrane. The support member also serves as a gas supply path positioned adjacent to the electrolyte membrane. The support member includes ventilation holes therein. The ventilation holes allow a gaseous fluid to pass therethrough, and enable the fluid to be supplied to the electrolyte membrane. For example, JP 2018-109221 A discloses an electrochemical hydrogen compressor in which a plurality of metal sheets having ventilation holes therein are stacked to thereby form an anode diffusion layer (support member). JP 2018-109221 A describes that, in an electrochemical cell, by the diameters of the vent holes of the metal sheets being made smaller as they become closer in proximity to the anode catalyst layer, the electrolyte membrane is prevented from becoming broken due to the differential pressure.

### SUMMARY OF THE INVENTION

In an electrolyte membrane that possesses hydrogen ion conductivity, electrical resistance increases as the amount of water therein decreases. As a result, the performance and efficiency of the electrochemical cell is reduced. Therefore, the hydrogen gas is humidified prior to being supplied to the electrochemical cell. The hydrogen gas is humidified by being passed through a bubbler. The humidified hydrogen gas supplies moisture to the electrolyte membrane. However, in the electrochemical cell under specific operating conditions, the amount of moisture supplied by the hydrogen gas to the electrolyte membrane becomes greater than the amount of moisture consumed by the electrolyte membrane. In this case, due to a differential pressure, excess moisture is returned from the cathode to the anode of the electrolyte membrane. Such excess moisture remains in the form of condensed water on the surface of the anode.

As a result, a reaction area between a gas to be treated such as hydrogen and the catalyst layer is reduced, whereby the electrical resistance (a potential between the electrodes) of the electrochemical cell is increased. Such an increase in the electrical resistance brings about a reduction in the ability with which the hydrogen is transported and a reduction in the energy efficiency of the electrochemical cell.

In a conventional electrochemical cell, constituent members such as a diffusion layer, a support member, or the like are covered by a water repelling agent in order to promote discharging of water that remains on a surface of the electrolyte membrane. These constituent members are subjected to a water repellent treatment in which the water repelling agent is applied thereto. However, since the water repellent treatment gradually deteriorates, a problem arises in that the long-term durability of such members is inferior.

Thus, one aspect of the present invention is to provide a support member for an electrochemical cell, and an electrochemical hydrogen compressor that are superior in terms of long-term durability.

One aspect of the following disclosure is characterized by a support a member for an electrochemical cell, wherein the support member is disposed adjacent to an anode of a membrane electrode assembly of the electrochemical cell, and is configured to support the membrane electrode assembly, comprising an anode current conductor one surface of which is in contact with and electrically connected to the anode of the membrane electrode assembly, and in which there are formed a plurality of ventilation holes configured to allow a fluid to pass therethrough in a thickness direction, and a plate-shaped flow field member in contact with another surface of the anode current conductor and configured to support the anode current conductor, wherein the flow field member further comprises flow field grooves configured to allow an anode gas to flow therethrough in a predetermined direction, and a plurality of through holes one ends of which open in the flow field grooves, and other ends of which are in communication with the ventilation holes of the anode current conductor, wherein at least a portion of the through holes are inclined at an acute angle with respect to an upstream side of the flow field grooves.

Another aspect is characterized by electrochemical hydrogen compressor, comprising a membrane electrode assembly, an anode separator disposed in an opposing relation to an anode of the membrane electrode assembly, a cathode separator disposed in an opposing relation to a cathode of the membrane electrode assembly, and a support member disposed between the membrane electrode assembly and the anode separator, wherein the support member comprises an anode current conductor one surface of which is in contact with and electrically connected to the anode of the membrane electrode assembly, and in which there are formed a plurality of ventilation holes configured to allow a fluid to pass therethrough in a thickness direction, and a plate-shaped flow field member in contact with another surface of the anode current conductor and configured to support the anode current conductor, wherein the flow field member further comprises flow field grooves configured to allow an anode gas to flow therethrough in a predetermined direction, and a plurality of through holes one ends of which open in the flow field grooves, and other ends of which are in communication with the ventilation holes of the anode current conductor, wherein at least a portion of the through holes are inclined at an acute angle with respect to an upstream side of the flow field grooves.

The support member for the electrochemical cell and the electrochemical hydrogen compressor having the above aspects are superior in terms of long-term durability, by enabling a water discharging performance in which, even without performing a water repellent treatment, the water discharging performance is the same or better than that of a case in which such a water repellent treatment is performed. Further, because the support member for the electrochemical cell and the electrochemical hydrogen compressor do not require the water repellent treatment, the manufacturing cost thereof can be reduced.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a cross-sectional view of a support member and an electrochemical hydrogen compressor according to a first embodiment, in which the cross section of FIG. 1 shows a cross section of a portion taken along line I-I of FIG. 2;

FIG. 2 is a plan view of a flow field member shown in FIG. 1;

FIG. 3 is a cross-sectional view of the electrochemical hydrogen compressor in a portion taken along line III-III of FIG. 2;

FIG. 4 is a cross-sectional view of the electrochemical hydrogen compressor in a portion taken along line IV-IV of FIG. 2;

FIG. 5A is an explanatory diagram of actions of supply path flow grooves;

FIG. 5B is an explanatory diagram of actions of discharge flow field grooves;

FIG. 6 is a plan view of the flow field member according to a second embodiment;

FIG. 7 is a cross-sectional view of an intermediate portion shown in FIG. 6; and

FIG. 8 is a plan view showing an arrangement layout of supply through holes, right-angled through holes, and discharge through holes of a flow field member having a circular planar shape.

### DESCRIPTION OF THE INVENTION

### First Embodiment

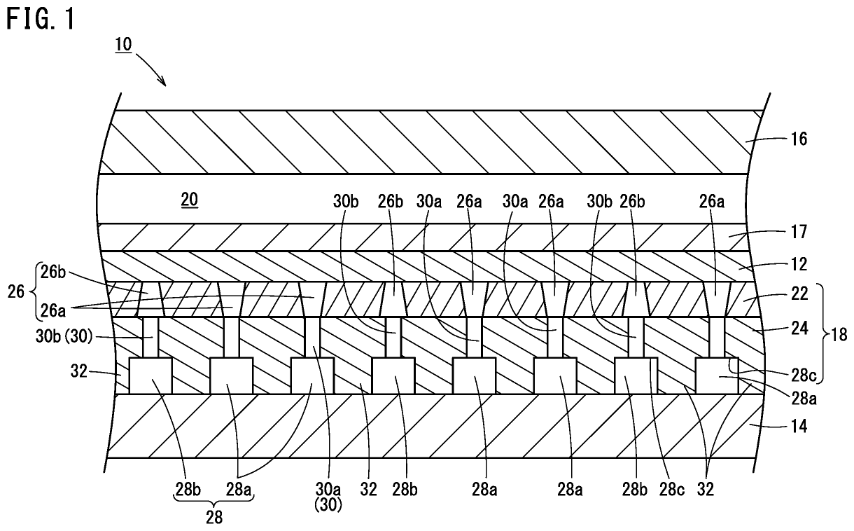

As shown in FIG. 1, in the present embodiment, a description is given concerning an electrochemical hydrogen compressor 10 which is one example of an electrochemical cell. The electrochemical hydrogen compressor 10 comprises a membrane electrode assembly (hereinafter, referred to as an “MEA 12”), an anode separator 14, a cathode separator 16, and a support member 18. The MEA 12 is sandwiched between the anode separator 14 and the cathode separator 16. The anode separator 14 and the cathode separator 16 are formed and configured, for example, by press forming into a corrugated shape a cross section of a steel plate, a stainless steel plate, an aluminum plate, a plated steel plate, or a thin metal plate subjected to an anti-corrosive surface treatment on the metal surface thereof.

The MEA 12 includes an electrolyte membrane, an anode disposed on one surface of the electrolyte membrane, and a cathode disposed on another surface of the electrolyte membrane. The electrolyte membrane is a solid polymer electrolyte membrane (cation ion exchange membrane). The solid polymer electrolyte membrane is formed by impregnating a thin membrane of perfluorosulfonic acid with water, for example. In addition to a fluorine based electrolyte, an HC (hydrocarbon) based electrolyte may be used in the electrolyte membrane. The electrolyte membrane is sandwiched between the anode and the cathode.

Although not shown in detail, the anode includes an anode catalyst layer connected to the one surface of the electrolyte membrane. The cathode includes a cathode catalyst layer connected to the other surface of the electrolyte membrane. As shown in FIG. 1, a cathode current conductor 17 is stacked on the cathode catalyst layer. The cathode current conductor 17 possesses the function of a gas diffusion layer. The cathode current conductor 17 includes, for example, a structure in which a plurality of metal meshes having different mesh diameters are stacked thereon. The size (mesh diameter) of the holes in each of the metal meshes that make up the cathode current conductor 17 becomes finer as the layers come in closer proximity to the MEA 12.

A high pressure hydrogen discharge flow field 20 through which compressed hydrogen gas flows through the cathode electrode is arranged between the MEA 12 and the cathode separator 16. Further, the support member 18 that supports the MEA 12 is arranged between the MEA 12 and the anode separator 14. The support member 18 includes an anode current conductor 22 adjacent to the anode of the MEA 12, and a flow field member 24 arranged between the anode current conductor 22 and the anode separator 14.

The anode current conductor 22 is a plate-shaped member formed of a conductive material such as metal or carbon or the like. The anode current conductor 22 abuts against the anode catalyst layer of the MEA 12, and supplies current to the MEA 12. The anode current conductor 22 also serves as a gas diffusion layer for supplying the hydrogen gas to the anode catalyst layer. The anode current conductor 22 includes a plurality of ventilation holes 26 that penetrate in the thickness direction thereof. Moreover, the anode current conductor 22 need not necessarily include the ventilation holes 26 that penetrate in the thickness direction thereof. For example, instead of the ventilation holes 26, the anode current conductor 22 may have a porous structure or a multilayer mesh structure. The porous structure or the multilayer mesh structure forms a flow field structure through which the hydrogen gas is allowed to flow in the thickness direction. More specifically, the anode current conductor 22 may have a configuration in which there are stacked a plurality of metal meshes in which the ventilation holes 26 of different diameters are formed. The ventilation holes 26 are not necessarily limited to a structure in which the ventilation holes 26 penetrate therethrough as a single hole in the thickness direction. The ventilation holes 26 may be configured such that a plurality of holes communicate with each other in the thickness direction. In this case, a change in the diameter of the ventilation holes 26 shown in the drawings reflects a change in the size (the mesh diameter) of the holes of each of the layers existing in the thickness direction.

The ventilation holes 26 of the anode current conductor 22 include supply ventilation holes 26a and discharge ventilation holes 26b. The supply ventilation holes 26a are holes that primarily take in the hydrogen gas from the flow field member 24 and supply the hydrogen gas to the MEA 12. The supply ventilation holes 26a have a shape in which the cross-sectional area thereof gradually changes in a manner so that the cross-sectional area at an end portion on a side separated away from the MEA 12 is smaller than the cross-sectional area thereof at an end portion on the side of the MEA 12. Within a plane of the anode current conductor 22, the supply ventilation holes 26a are arranged at a location so as to be capable of communicating with supply flow field grooves 28a to be described later. In the case that the anode current conductor 22 is configured by stacking the plurality of metal meshes, the metal meshes may be stacked in a region that forms the supply ventilation holes 26a, in an order in which the mesh diameters thereof become greater as the meshes become closer in proximity to the MEA 12.

On the other hand, the discharge ventilation holes 26b are holes that primarily carry out a function of discharging the condensed water together with the hydrogen gas from the side of the MEA 12. The discharge ventilation holes 26b have a shape in which the cross-sectional area thereof gradually changes in the thickness direction. The cross-sectional area at an end portion of the discharge ventilation holes 26b on a side separated away from the MEA 12 is greater than the cross-sectional area thereof at an end portion on the side of the MEA 12. Within a plane of the anode current conductor 22, the discharge ventilation holes 26b are arranged at a location so as to be capable of communicating with discharge flow field grooves 28b to be described later. In the case that the anode current conductor 22 is configured by stacking the plurality of metal meshes, the metal meshes may be stacked in a region that forms the discharge ventilation holes 26b, in an order in which the mesh diameters thereof become smaller as the meshes become closer in proximity to the MEA 12.

The flow field member 24 is arranged between the anode current conductor 22 and the anode separator 14. The flow field member 24, for example, is a plate-shaped member made of metal or the like. The flow field member 24 comprises flow field grooves 28 which are formed on a surface on the side of the anode separator 14, and through holes 30 that enable communication between the flow field grooves 28 and the anode current conductor 22.

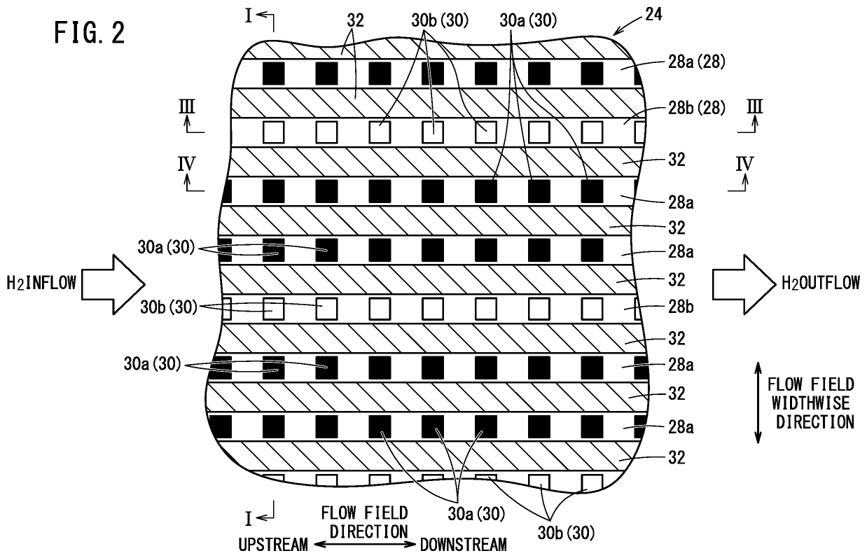

As shown in FIG. 2, the flow field member 24 includes a plurality of the flow field grooves 28 which extend in a straight line shape on a surface on the side of the anode separator 14. The flow field grooves 28 are groove-shaped portions formed between a plurality of convex portions 32 that extend in a flow field direction. The flow field grooves 28 form gaps that extend in the flow field direction between the anode separator 14 (see FIG. 1) and the flow field grooves 28. The hydrogen gas flows through the flow field grooves 28 from an upstream side toward a downstream side shown in FIG. 2.

According to the present embodiment, the flow field grooves 28 are constituted by supply flow field grooves 28a and discharge flow field grooves 28b. The supply flow field grooves 28a primarily have a function of supplying the hydrogen gas to the MEA 12. On the other hand, the discharge flow field grooves 28b primarily have a function of allowing the condensed water discharged from the MEA 12 to flow out. The discharge flow field grooves 28b are arranged adjacent to the supply flow field grooves 28a in the flow field widthwise direction. Although not particularly limited to this feature, the number of the discharge flow field grooves 28b is smaller than the number of the supply flow field grooves 28a. Moreover, the percentage of the discharge flow field grooves 28b can be appropriately adjusted corresponding to the amount of the condensed water generated by the MEA 12.

One ends of the through holes 30 open in a bottom portion 28c of the flow field grooves 28 of the flow field member 24. The through holes 30 include supply through holes 30a and discharge through holes 30b. The supply through holes 30a open in the supply flow field grooves 28a and communicate with the supply flow field grooves 28a. A plurality of the supply through holes 30a are arranged along the supply flow field grooves 28a at regular intervals in the flow field direction. The discharge through holes 30b open in the discharge flow field grooves 28b and communicate with the discharge flow field grooves 28b. A plurality of the discharge through holes 30b are arranged along the discharge flow field grooves 28b at regular intervals in the flow field direction.

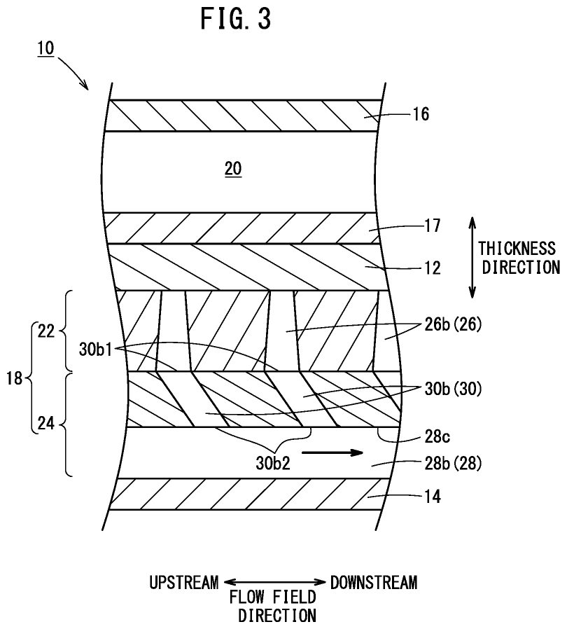

As shown in FIG. 3, the discharge through holes 30b extend in an inclined manner with respect to the thickness direction of the flow field member 24. The discharge through holes 30b are inclined in a manner so that MEA side end portions 30b1 of the discharge through holes 30b are positioned on a more upstream side in the flow field direction than separator side end portions 30b2 of the discharge through holes 30b. More specifically, the discharge through holes 30b are inclined at an acute angle with respect to the upstream side of the flow field member 24. The discharge through holes 30b open toward the downstream side.

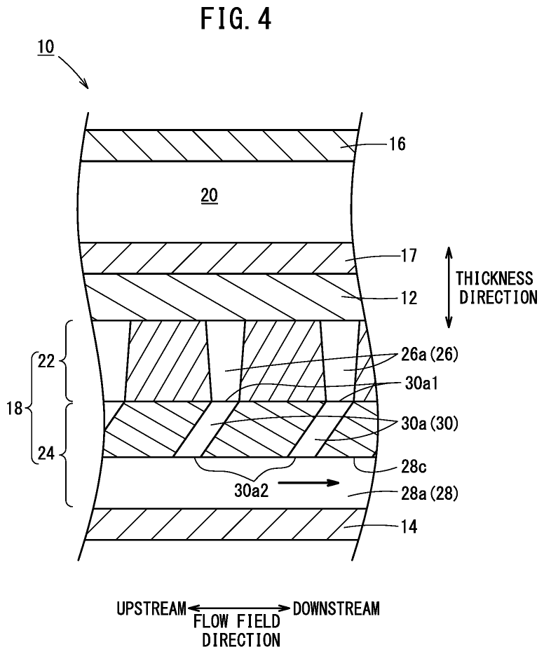

As shown in FIG. 4, the supply through holes 30a extend in an inclined manner with respect to the thickness direction of the flow field member 24. The supply through holes 30a are inclined in a manner so that MEA side end portions 30a1 of the supply through holes 30a are positioned on a more downstream side in the flow field direction than separator side end portions 30a2 of the supply through holes 30a. More specifically, the supply through holes 30a are inclined at an obtuse angle with respect to the upstream side of the flow field member 24. The supply through holes 30a open toward the upstream side.

A cross-sectional area of a cross section perpendicular to a central axis of the discharge through holes 30b is greater than a cross-sectional area of a cross section perpendicular to a central axis of the supply through holes 30a.

The support member 18 for an electrochemical cell and the electrochemical hydrogen compressor 10 of the present embodiment are configured in the manner described above. Hereinafter, operations of the support member 18 and the electrochemical hydrogen compressor 10 will be described.

As shown in FIG. 2, the hydrogen gas flows through the flow field grooves 28 (the supply flow field grooves 28a and the discharge flow field grooves 28b) of the electrochemical hydrogen compressor 10 from an upstream side to a downstream side along the flow field direction.

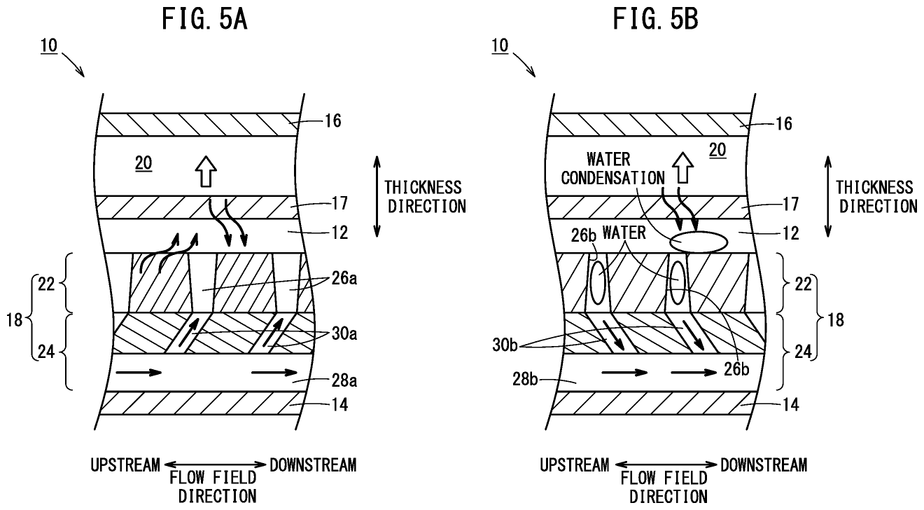

As shown in FIG. 5A, in the supply flow field grooves 28a, the hydrogen gas flows into the supply through holes 30a. The supply through holes 30a are inclined and open toward the upstream side. Proceeding along with such a flow, the hydrogen gas in the supply flow field grooves 28a efficiently flows into the supply through holes 30a. The hydrogen gas passes through the anode current conductor 22, and is supplied to the MEA 12.

An electrical current is supplied to the MEA 12 through the anode current conductor 22 and the cathode current conductor 17. The hydrogen gas supplied to the anode is transported through the MEA 12 to the cathode in the form of hydrogen ions. The transported hydrogen ions generate a high pressure hydrogen gas at the cathode. Moisture is added through a bubbler or the like as a vapor to the hydrogen gas that is supplied to the electrochemical hydrogen compressor 10. The hydrogen gas serves to humidify the MEA 12 through a portion of the water vapor.

As shown in FIG. 5B, when excess water vapor exists in the MEA 12, the excess water vapor is condensed in the MEA 12. The condensed water vapor becomes water in the form of dew condensation at the anode of the MEA 12. Such water in the form of dew condensation flows into the discharge ventilation holes 26b of the anode current conductor 22. Due to a capillary effect, the condensed water that has flowed into the discharge ventilation holes 26b moves to a side separated away from the MEA 12.

The condensed water passes through the discharge ventilation holes 26b, and flows into the discharge through holes 30b of the flow field member 24. The discharge through holes 30b are inclined toward a downstream side of the discharge flow field grooves 28b. Therefore, due to the flow of the hydrogen gas in the discharge flow field grooves 28b, a negative pressure is generated in the discharge through holes 30b. The condensed water in the discharge through holes 30b is drawn out in accordance with the flow of the hydrogen gas, and is discharged from the discharge through holes 30b. The condensed water is discharged from the electrochemical hydrogen compressor 10 together with the hydrogen gas in the discharge flow field grooves 28b.

### Second Embodiment

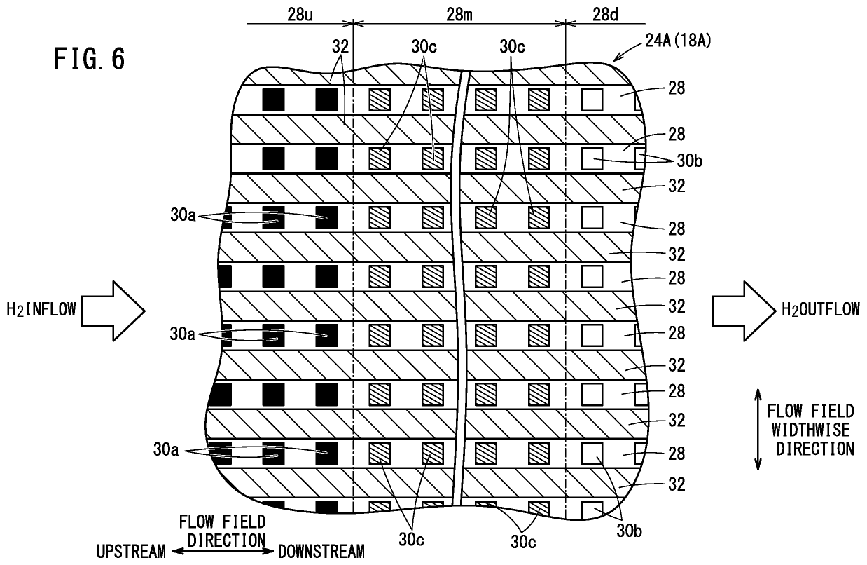

In the present embodiment, a description will be given with reference to FIGS. 6 to 8 concerning a support member 18A in which the arrangement layout of the supply through holes 30a and the discharge through holes 30b is modified. In the configuration of the support member 18A according to the present embodiment, the same constituent elements as those corresponding to the support member 18 described with reference to FIGS. 1 to 5 are designated by the same reference numerals, and detailed description of such features is omitted.

The support member 18A of the present embodiment includes a flow field member 24A shown in FIG. 6, instead of the flow field member 24 shown in FIG. 2. The flow field member 24A includes a plurality of flow field grooves 28 which extend in a straight line shape on a surface in closer proximity to the anode separator 14. According to the present embodiment, the flow field grooves 28 are not divided into supply flow field grooves 28a and discharge flow field grooves 28b, and supply through holes 30a and discharge through holes 30b are disposed in each of the flow field grooves 28.

Each of the flow field grooves 28 includes an upstream portion 28u, an intermediate portion 28m, and a downstream portion 28d. The upstream portion 28u is positioned on an upstream side in the direction in which the hydrogen gas flows. The downstream portion 28d is positioned on a downstream side in the direction in which the hydrogen gas flows. The intermediate portion 28m is positioned between the upstream portion 28u and the downstream portion 28d.

Each of the flow field grooves 28 includes supply through holes 30a, discharge through holes 30b, and right-angled through holes 30c. As was described with reference to FIG. 4, the supply through holes 30a open in the upstream side, by being inclined at an obtuse angle with respect to the upstream side of the flow field grooves 28. As shown in FIG. 6, the supply through holes 30a are arranged in the upstream portion 28u of the flow field grooves 28. As was described with reference to FIG. 3, the discharge through holes 30b open in the downstream side, by being inclined at an acute angle with respect to the upstream side of the flow field grooves 28. As shown in FIG. 6, the discharge through holes 30b are arranged in the downstream portion 28d of the flow field grooves 28.

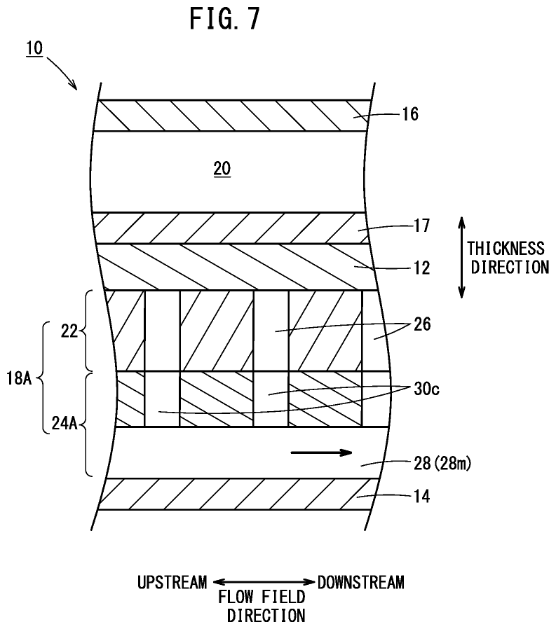

As shown in FIG. 7, the right-angled through holes 30c are through holes that extend at a right angle with respect to the direction in which the flow field grooves 28 extend. As shown in FIG. 6, the right-angled through holes 30c are arranged in the intermediate portion 28m.

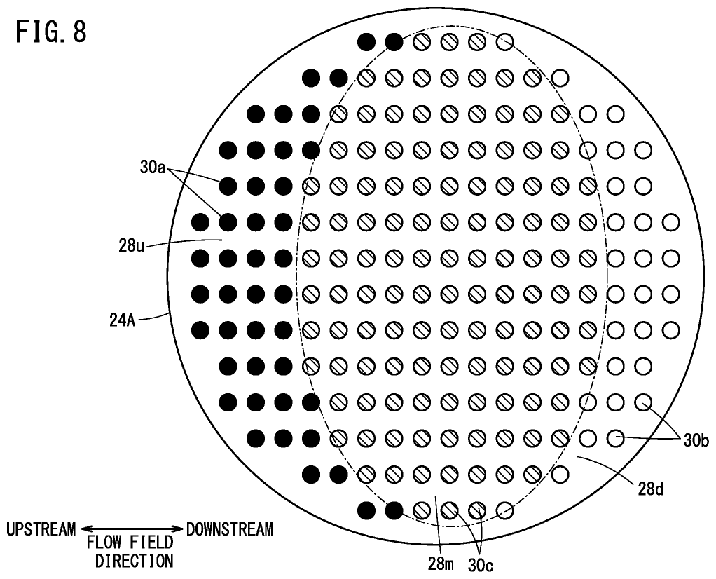

As shown in FIG. 8, the flow field member 24A can be formed, for example, in a circular planar shape. In this case, as shown in the drawing, respective ranges of the upstream portion 28u, the intermediate portion 28m, and the downstream portion 28d are increased or decreased according to the length of the flow field grooves 28. The right-angled through holes 30c are arranged in an elliptical region in proximity to the center of the flow field member 24A.

The support member 18A for the electrochemical cell includes the flow field member 24A which is configured in the manner described above. In the MEA 12, the hydrogen in the upstream portion 28u of the flow field grooves 28 has a tendency of becoming low. Further, the MEA 12 has a tendency of making it likely for excess moisture to be retained in the downstream portion 28d of the flow field grooves 28. In the flow field member 24A according to the present embodiment, the supply through holes 30a are arranged in the upstream portion 28u, and the discharge through holes 30b are arranged in the downstream portion 28d. Such a flow field member 24A can appropriately carry out supplying of the hydrogen and discharging of the moisture in accordance with the state in which the moisture is distributed in the MEA 12. Accordingly, the support member 18A in which the flow field member 24A is included is capable of improving the performance of the electrochemical hydrogen compressor 10, and can increase the amount (amount of processing) of the hydrogen gas that is processed.

Although in the foregoing, preferred embodiments of the present invention have been described, the present invention is not limited to the embodiments, and various modifications can be adopted therein without departing from the essence and gist of the present invention.

The embodiments described above can be summarized in the following manner.

In the embodiments described above, there is disclosed the support member (18) for the electrochemical cell, wherein the support member is disposed adjacent to the anode (12) of the membrane electrode assembly of the electrochemical cell, and which supports the membrane electrode assembly, comprising the anode current conductor (22) one surface of which is in contact with and electrically connected to the anode of the membrane electrode assembly, and in which there are formed the plurality of ventilation holes (26) that allow the fluid to pass therethrough in the thickness direction, and the plate-shaped flow field member (24) in contact with another surface of the anode current conductor, and which supports the anode current conductor, wherein the flow field member further comprises the flow field grooves (28) that allow the anode gas to flow therethrough in a predetermined direction, and the plurality of through holes (30) the one ends of which open in the flow field grooves, and the other ends of which are in communication with the ventilation holes of the anode current conductor, wherein at least a portion of the through holes are inclined at an acute angle with respect to the upstream side of the flow field grooves. In accordance with the support member that is configured in this manner, a drainage performance can be exhibited which is the same or better than a case in which a water repellent treatment is performed, and the long-term durability and reliability of the electrochemical cell are improved. Further, since the support member is capable of discharging the anode gas from the anode current conductor, it is possible to prevent the anode gas from remaining in the vicinity of the anode current conductor.

The through holes include the supply through holes (30a) and the discharge through holes (30b) with different directions of inclination, and the discharge through holes are inclined at an acute angle with respect to the upstream side of the flow field grooves, and open toward the downstream side of the flow field grooves. The discharge through holes create a negative pressure due to the flow of the anode gas that flows through the flow field grooves. The discharge through holes promote discharging of the condensed water by drawing in the condensed water. Consequently, the support member prevents the occurrence of stagnant water in the vicinity of the anode current conductor.

The supply through holes are inclined at an obtuse angle with respect to the upstream side of the flow field grooves, and open toward the upstream side of the flow field grooves. Since the anode gas flowing through the flow field grooves easily flows into the supply through holes, the hydrogen gas can be efficiently supplied to the membrane electrode assembly. Further, since the support member supplies the anode gas to the anode current conductor while maintaining the flow velocity of the anode gas, it is possible to prevent the anode gas from remaining in the vicinity of the anode current conductor.

The supply through holes and the discharge through holes are formed, respectively, in a plurality, together with the discharge through holes being disposed so as to be sandwiched between the supply through holes, in relation to the flow field widthwise direction of the flow field grooves. Such an arrangement layout of the supply through holes enables the stagnant water to be efficiently discharged through the adjacent discharge through holes, and therefore, prevents the occurrence of flooding in which the stagnant water blocks the flow fields.

The flow field grooves include the supply flow field grooves (28a) that communicate with the plurality of the supply through holes provided along the flow field direction, and the discharge flow field grooves (28b) that communicate with the plurality of the discharge through holes provided along the flow field direction.

The supply flow field grooves and the discharge flow field grooves are provided as a plurality in parallel while being separated in the flow field widthwise direction.

The plurality of the supply through holes are disposed in an upstream portion (28u) which is an upstream side of the flow field grooves, and the plurality of the discharge through holes are disposed in a downstream portion (28d), which is the downstream side of the flow field grooves in which the supply through holes are arranged. The arrangement of the supply through holes and the discharge through holes in this manner can appropriately control supplying of the hydrogen and discharging of the condensed water, and brings about an improvement in the performance of the electrochemical cell and an improvement in the amount of processing.

The through holes further comprise the right-angled through holes (30c) that extend in a direction perpendicular to the direction in which the flow field grooves extend, and the right-angled through holes are arranged in the intermediate portion (28m) between the upstream portion and the downstream portion of the flow field grooves. Such an arrangement of the through holes improves the balance between the supplying of the hydrogen and the discharging of the condensed water, and brings about in an improvement in the performance of the electrochemical cell and an improvement in the amount of processing.

The number of the discharge through holes is smaller than the number of the supply through holes. Suppressing the number of the discharge through holes increases the flow velocity of the gas flowing through the flow fields, and promotes efficient discharging of the condensed water.

The cross-sectional area of the discharge through holes is greater than the cross-sectional area of the supply through holes. Suppressing the cross-sectional area of the discharge through holes increases the flow velocity flowing through the flow fields, and promotes efficient discharging of the condensed water.

In the embodiments described above, there is disclosed the electrochemical hydrogen compressor (10), comprising the membrane electrode assembly (12), the anode separator (14) disposed in an opposing relation to the anode of the membrane electrode assembly, the cathode separator (16) disposed in an opposing relation to the cathode of the membrane electrode assembly, and the support member (18) disposed between the membrane electrode assembly and the anode separator, wherein the support member comprises the anode current conductor (22) one surface of which is in contact with and electrically connected to the anode of the membrane electrode assembly, and in which there are formed the plurality of ventilation holes (26) that allow the fluid to pass therethrough, and the plate-shaped flow field member (24) in contact with the other surface of the anode current conductor, and which supports the anode current conductor, wherein the flow field member further comprises the flow field grooves (28) that allow the anode gas to flow therethrough in a predetermined direction, and the plurality of through holes (30) the one ends of which open in the flow field grooves, and the other ends of which are in communication with the ventilation holes of the anode current conductor, wherein at least a portion of the through holes are inclined at an acute angle with respect to the upstream side of the flow field grooves.

What is claimed is:

1. A support member for an electrochemical cell, wherein the support member is disposed adjacent to an anode of a membrane electrode assembly of the electrochemical cell, and is configured to support the membrane electrode assembly, comprising:
an anode current conductor one surface of which is in contact with and electrically connected to the anode of the membrane electrode assembly, and in which there are formed a plurality of ventilation holes configured to allow a fluid to pass therethrough in a thickness direction; and
a plate-shaped flow field member in contact with another surface of the anode current conductor and configured to support the anode current conductor;
wherein the flow field member further comprises:
flow field grooves configured to allow an anode gas to flow therethrough in a predetermined direction; and
a plurality of through holes one ends of which open in the flow field grooves, and other ends of which are in communication with the ventilation holes of the anode current conductor;
wherein at least a portion of the through holes are inclined at an acute angle with respect to an upstream side of the flow field grooves.

2. The support member for an electrochemical cell according to claim 1, wherein the through holes include supply through holes and discharge through holes with different directions of inclination, and the discharge through holes are inclined at an acute angle with respect to the upstream side of the flow field grooves, and open toward a downstream side of the flow field grooves.

3. The support member for an electrochemical cell according to claim 2, wherein the supply through holes are inclined at an obtuse angle with respect to the upstream side of the flow field grooves, and open toward the upstream side of the flow field grooves.

4. The support member for an electrochemical cell according to claim 2, wherein the supply through holes and the discharge through holes are formed, respectively, in a plurality, together with the discharge through holes being disposed so as to be sandwiched between the supply through holes, in relation to a flow field widthwise direction of the flow field grooves.

5. The support member for an electrochemical cell according to claim 2, wherein the flow field grooves include supply flow field grooves configured to communicate with a plurality of the supply through holes provided along a flow field direction, and discharge flow field grooves configured to communicate with a plurality of the discharge through holes provided along the flow field direction.

6. The support member for an electrochemical cell according to claim 5, wherein the supply flow field grooves and the discharge flow field grooves are provided as a plurality in parallel while being separated in a flow field widthwise direction.

7. The support member for an electrochemical cell according to claim 2, wherein:
a plurality of the supply through holes are disposed in an upstream portion which is an upstream side of the flow field grooves; and
a plurality of the discharge through holes are disposed in a downstream portion, which is the downstream side of the flow field grooves in which the supply through holes are arranged.

8. The support member for an electrochemical cell according to claim 7, wherein:
the through holes further include right-angled through holes extending in a direction perpendicular to a direction in which the flow field grooves extend; and
the right-angled through holes are arranged in an intermediate portion between the upstream portion and the downstream portion of the flow field grooves.

9. The support member for an electrochemical cell according to claim 4, wherein a number of the discharge through holes is smaller than a number of the supply through holes.

10. The support member for an electrochemical cell according to claim 2, wherein a cross-sectional area of the discharge through holes is greater than a cross-sectional area of the supply through holes.

11. An electrochemical hydrogen compressor, comprising
a membrane electrode assembly;
an anode separator disposed in an opposing relation to an anode of the membrane electrode assembly;
a cathode separator disposed in an opposing relation to a cathode of the membrane electrode assembly; and
a support member disposed between the membrane electrode assembly and the anode separator;
wherein the support member comprises:
an anode current conductor one surface of which is in contact with and electrically connected to the anode of the membrane electrode assembly, and in which there are formed a plurality of ventilation holes configured to allow a fluid to pass therethrough in a thickness direction; and
a plate-shaped flow field member in contact with another surface of the anode current conductor and configured to support the anode current conductor;
wherein the flow field member further comprises:
flow field grooves configured to allow an anode gas to flow therethrough in a predetermined direction; and
a plurality of through holes one ends of which open in the flow field grooves, and other ends of which are in communication with the ventilation holes of the anode current conductor;
wherein at least a portion of the through holes are inclined at an acute angle with respect to an upstream side of the flow field grooves.
